(19) United States
(12) Patent Application Publication
(10) Pub. No.: US 2023/0287227 A1
(43) Pub. Date: Sep. 14, 2023

(54) WATER-BASED INK COMPOSITION WITH COLOR-CHANGING BY EVAPORATION

(71) Applicant: SOCIÉTÉ BIC, Clichy (FR)

(72) Inventor: Damien CONCEDIEU, Clichy (FR)

(73) Assignee: SOCIÉTÉ BIC, Clichy (FR)

(21) Appl. No.: 17/997,510

(22) PCT Filed: Apr. 28, 2021
(86) PCT No.: PCT/EP2021/061189

§ 371 Date: Oct. 28, 2022

(30) Foreign Application Priority Data
Apr. 30, 2020 (EP) 20305423.4

(51) Int. Cl. C09D 11/17; C09D 11/50

(52) U.S. Cl. CPC C09D 11/17; C09D 11/50; B43K 8/024

(57) ABSTRACT

The present disclosure concerns a water-based color-changing ink composition with two different states of color over time, an initial color A and then a second color B which is not colorless, comprising a volatile pH-modifier base capable of evaporating at room temperature (20° C.), a pH-sensitive dye, and an optional non-pH sensitive dye. The disclosure also concerns a method for preparing such color-changing ink composition. A writing instrument comprising such color-changing ink composition, and a kit comprising such color-changing ink composition and an eradicator, as well as methods for writing on a substrate, are also part of the disclosure. Finally, the disclosure aims at a substrate coated with a color-changing ink composition according to the disclosure.

### CROSS REFERENCE TO RELATED APPLICATIONS

This application is a National Stage Application of International Application No. PCT/EP2021/061189, filed on Apr. 28, 2021, now published as WO2021219754 and which claims priority from European Application No. EP 20305423.4, filed on Apr. 30, 2020, the entire contents of which is incorporated herein by reference.

### TECHNICAL FIELD

The present disclosure concerns a water-based color-changing ink composition with two different states of color over time, an initial color A and then a second color B which is not colorless, comprising a volatile pH-modifier base capable of evaporating at room temperature (20° C.), a pH-sensitive dye, and an optional non-pH sensitive dye. The disclosure also concerns a method for preparing such color-changing ink composition. A writing instrument comprising such color-changing ink composition, and a kit comprising such color-changing ink composition and an eradicator, as well as methods for writing on a substrate, are also part of the disclosure. Finally, the disclosure aims at a substrate coated with a color-changing ink composition according to the disclosure.

### BACKGROUND

Color-changing inks generally include two components. One component is an aqueous ink including a dye that can substantially change color when contacted with a substance that can lead the dye to convert in another color. A user writes on a substrate with the ink and, if color-change is needed, applies to the ink marking a substance that can change the color of the dye.

EP1006216 illustrates for instance an ink composition comprising a dye that can be made colorless or that can be converted into a color that matches that of the substrate (e.g. white for white paper), by chemical eradication, upon the application of an oxidizing agent. The method of ink marking described in this document thus involves two steps: the first is the marking of a substrate with an ink, and the second is the application of an eradication solution to the marking.

Color-changing inks in one instrument may exist but require a subsequent mechanical action, the color-changing appearing after upon erasure of the inks. For example, US5,534,587 discloses a color-changeable marking composition for drawing and coloring activities, the composition comprising (a) an emulsion having an aqueous continuous phase with a basic pH and a noncarboxylated styrene-butadiene rubber latex discontinuous phase; (b) a pigment insoluble in the aqueous continuous phase of the emulsion; and (c) an acid dye soluble in the aqueous continuous phase of the emulsion, the acid dye having a different color than the water-insoluble pigment. Upon contact with the surface of a marking substrate, the emulsion breaks, causing the aqueous continuous phase to be absorbed by the substrate and the rubber latex discontinuous phase to form a cohesive film on the surface of the substrate. The acid dye, because of its solubility in the aqueous continuous phase, is also absorbed by the substrate and cannot be removed therefrom. The pigment, because of its insolubility in the aqueous continuous phase, becomes associated with the cohesive film and can easily be removed from the substrate by stripping the cohesive film from the substrate using an ordinary pencil eraser.

### SUMMARY

The color-changing ink composition of the disclosure has the advantage over the prior art ink compositions of being included in one single writing instrument, without the need for a second instrument (such as an eradicator) to change the ink color. This allows having multiple color options when the user takes notes, journal or draws to emphasize information or to make things stand out, which allows the user not to use multiple writing instruments. The ink composition of the disclosure also does not require any action from the user, the color-changing more specifically occurring within 30 minutes, and more more specifically 15 minutes, after application to the substrate, and more specifically the color-changing occurring within at least 10 seconds, and more more specifically within at least 30 seconds, after application to the substrate, by simple evaporation at room temperature (20° C.), without any external action to be done by the user, more specifically without having to rub the first (initial) color to reveal a second color.

The inventors have surprisingly found that the use of a volatile pH-modifier base capable of evaporating at room temperature (20° C.), in combination with a pH-sensitive dye and possibly a non-pH sensitive dye, dissolved in water, may lead to a color-changing ink composition with the above-mentioned advantages. The aqueous color-changing ink composition of the disclosure presents, more specifically, two different states of color over time, and offers the advantage of changing color from an initial color A to a second color B, the second color B not being colorless, and wherein the second color B is different from the initial (first) color A, by evaporation of a volatile pH-modifier base at room temperature (20° C.). When the color-changing ink composition of the disclosure is applied on a substrate, the volatile base thus evaporates modifying the pH of the ink composition, and therefore changing the color of the pH-sensitive dye also present in the ink composition. Hence, the initial (first) color A of the ink composition after writing on a substrate changes into a second color B which is not colorless, the initial and second colors being different from each other. More specifically, according to the present disclosure, “the initial (first) color and second color being different from each other” means that these two colors can be distinguished from each other by the human eye. More specifically, the difference of density of color between the second color B and initial (first) color A measured in the CIE L*a*b is more specifically superior than 2, and even more specifically superior than 3. The density of color can be measured in the CIE L*a*b* system using a Konica Minolta CM-3610 (illuminant D65, angle 10°).

The ink composition of the disclosure is more specifically suitable for use with writing substrates, more specifically porous substrates (also named porous surfaces) made, basically, of pressed, matted fibers, like paper or cardboard. The color-changing ink composition of the disclosure is also storage-stable, easy to manufacture, and easy to apply. According to some embodiment, the color-change occurs within 30 minutes, more specifically 15 minutes, after application to the substrate, and more specifically the color-change occurs within at least 10 seconds, more specifically within at least 30 seconds, by simple evaporation at room temperature (20° C.), without having to rub the first (initial) color to reveal the second color.

An additional advantage of the disclosure is the possibility to obtain an ink composition with color-changing having a good cap-off time. The term “cap-off” designated the ability of the ink composition of the disclosure with color-changing of not drying up in the writing instrument, which means more specifically that the writing instrument can be left open for longer period of time, more specifically several minutes, more specifically with removed cap, without drying up.

### DETAILED DESCRIPTION

Hereinafter, a detailed description of the present disclosure will be given. The specific embodiments are meant better illustrate the present disclosure, however, it should be understood that the present disclosure is not limited to these specific embodiments.

In the sense of the present disclosure, the expression “comprising a” should be understood as being synonymous with “comprising at least one”.

In the sense of the present disclosure, the expression “ranging from ... to ...” should be understood as including the values of the limits.

The term “color-changing” is intended to mean that the ink composition has two different states of color over time: a first (initial) color A and then a second color B, said second color B being different from the initial color A and not colorless. More specifically, this means that the second color B can be distinguished from the initial (first) color A by the human eye, more specifically the difference of density of color between the second color B and initial (first) color A is superior than 2, more specifically is superior than 3, when measured in the CIE L*a*b. When the color-change has occurred, the written mark made with the color-changing ink composition of the disclosure cannot change again spontaneously, and more specifically it is not possible to go back to the initial color A, without a specific intervention of the user.

For the purposes of the present disclosure, the term “porous substrate” is intended to mean substrate that contains pores. The porous substrates have empty spaces or pores that allow external matter, like ink, to penetrate into the substrate. More specifically, the roughness of the substrate can be defined by its air permeability and measured by the standard ISO 8791 (unit: mL.min⁻¹). In some embodiments, the air permeability of the porous substrate of the disclosure ranges from 50 to 1,000 mL.min⁻¹, more specifically from 60 to 400 mL.min⁻¹, and more specifically from 80 to 280 mL.min⁻¹. More specifically, the porous substrate is chosen among porous substrate comprising cellulosic fibers such as paper, printer paper, or cardboard.

The ink composition according to the present disclosure is more specifically a writing ink. For the purposes of the present disclosure, the term “writing ink” is intended to mean any ink which is intended to be used in a writing instrument, and more specifically in a gel pen, a roller-pen, a free-ink pen, a felt-pen, a marker. A writing ink should not be confused with a printing ink which is used in printing machines and which does not have the same technical constraints, and thus the same specifications. Indeed, a writing ink must not contain solid particles of which the size is greater than the channels of the writing instrument, in order to avoid blocking them, which would inevitably lead to writing being irreversibly stopped. It must also dry sufficiently rapidly to avoid smudging the writing medium. It must also avoid the problems of migration (bleeding) over time. Thus, the ink composition according to the present disclosure will be suitable for the writing instrument for which it is intended.

The present disclosure thus concerns a color-changing ink composition with two different states of color over time, an initial color A and then a second color B which is not colorless, comprising:
water,
at least one volatile pH-modifier base capable of evaporating at room temperature (20° C.),
at least one first pH-sensitive dye,
optionally, at least one non-pH sensitive dye, and/or
optionally, at least one second pH-sensitive dye which is always colored.

In some embodiments, the color-changing ink composition of the disclosure is exempt of eradicator agent(s), more specifically of eradicator agent(s) chosen in the group consisting of sulfite, bisulfite, amine, and mixtures thereof, and even more specifically of eradicator agent(s) chosen in the group consisting of sodium sulfite, sodium glycinate, and mixtures thereof.

The color-changing ink composition of the disclosure is a water-based color-changing ink composition containing water (a) as a solvent. In some embodiments, the content of water (a) ranges from 10 to 95% by weight, more specifically from 30 to 90% by weight, and more specifically 50 to 85% by weight, relative to the total weight of the ink composition.

In the sense of the disclosure, a “volatile pH-modifier base” is a base and capable of evaporating at room temperature (20° C.) and at constant air pressure.

In some embodiments, the “volatile pH-modifier base” is in liquid form at 20° C. and at constant air pressure.

In some embodiments, the “volatile pH-modifier base” has a vapor pressure ranging from 1 kPa to 1,000 kPa, more specifically ranging from 10 kPa to 500 kPa, and even more specifically ranging from 50 kPa to 300 kPa, at room temperature (20° C.) and at constant air pressure.

In some embodiments, the “volatile pH-modifier base” has a flash point below 100° C., more specifically below 80° C., and even more specifically below 50° C.

In some embodiments, the “volatile pH-modifier base” has a boiling temperature below 100° C.

According to some embodiment, “the volatile pH-modifier base” has a boiling temperature between 20 and 100° C., and more specifically ranging from 30 to 90° C.

According to some specific embodiment, the volatile pH-modifier base (b) has a boiling point of higher than -10° C. and of below 100° C., more specifically of higher than -10° C. and of below 60° C., even more specifically of higher than -10° C. and of below 10° C.

The volatile pH-modifier base (b) of the disclosure can be an aliphatic amine, more specifically a primary or secondary aliphatic amine in C₁-C₆, and even more specifically a primary or secondary aliphatic amine in C₁-C₄. In some embodiments, the volatile pH-modifier base (b) of the disclosure is a non-hydroxylated aliphatic amine, more specifically a non-hydroxylated primary or secondary aliphatic amine in C₁-C₆, and even more specifically a non-hydroxylated primary or secondary aliphatic amine in C₁-C₄.

More specifically, the volatile pH-modifier base (b) is a non-hydroxylated aliphatic amine in C₁-C₄, more specifically in C₁-C₂.

More specifically the volatile pH-modifier base (b) is secondary aliphatic amine in C₁-C₆, more specifically in C₁-C₄, more specifically dimethylamine and/or diethylamine, more specifically dimethylamine. More specifically the secondary aliphatic amine is a non-hydroxylated secondary aliphatic amine.

In a more specific embodiment, the at least one volatile pH-modifier base (b) is chosen in the group consisting of methylamine, dimethylamine, diethylamine, triethylamine, or mixtures thereof, more specifically chosen in the group consisting of methylamine, dimethylamine, diethylamine, or mixtures thereof, more specifically chosen in the group consisting of methylamine, dimethylamine, even more specifically dimethylamine.

In the sense of the disclosure, the “pH-sensitive dye” is a dye with a color depending on the pH, and that changes color at a specific pH value.

In the sense of the disclosure, the “non-pH sensitive dye” (d) is a dye having a color that does not change color depending on the pH.

According to a more specific embodiment of the color-changing ink composition of the disclosure, the at least one volatile pH-modifier base (b) has a pH greater than the specific color-change pH value of the at least one first pH-sensitive dye (c).

More specifically, the color-changing ink composition of the disclosure, comprising the at least one volatile pH-modifier base (b) has a pH greater than the specific color-change pH value of the at least one first pH-sensitive dye (c).

In some embodiments, the color-change pH value of the first pH-sensitive dye(s) (c) and/or optional second pH-sensitive dye(s) (e) which is always colored (i.e. the pH at which it changes color) is(are) greater than the pH of the ink composition exempt of the at least one volatile pH-modifier base (b).

In some embodiments, the color-change pH value of the first pH-sensitive dye(s) (c) and/or optional second pH-sensitive dye(s) (e) which is always in a colored state is(are) greater than the pH of the porous substrate (also called porous surface), more specifically said porous substrate comprising cellulosic fibers is chosen among paper, printer paper or cardboard.

In some embodiments, the content of volatile pH-modifier base(s) (b) ranges from 0.8 to 6% by weight, more specifically from 1 to 6% by weight, and even more specifically from 1.6 to 4.8% by weight, relative to the total weight of the ink composition.

In some embodiments, when the volatile pH-modifier base(s) (b) is an aliphatic amine, more specifically a secondary aliphatic amine, the content of volatile pH-modifier base(s) (b) (more specifically of aliphatic amine) ranges from 0.8 to 6% by weight, more specifically from 1 to 6% by weight, and even more specifically from 1.6 to 4.8% by weight, relative to the total weight of the ink composition.

In some embodiments, the content of volatile pH-modifier base(s) (b) is in excess weight with respect to the minimum content of volatile pH-modifier base(s) (b) necessary to obtain the color-changing pH of the ink composition of the disclosure. This means that the weight content of pH-modifier base(s) (b) that is added to the ink composition of the disclosure should be more specifically higher than the minimum weight content of volatile pH-modifier base(s) (b) that is needed to reach the pH necessary for obtaining a color-change of the ink composition of the disclosure.

The first pH-sensitive dye(s) (c) can be chosen in the group consisting of acid dyes (for example C.I. acid black AX991, AY339; C.I. acid blue 1, 22, 74, 92, 93, 110, AX989, AX993, AX987; C.I. acid green 3, 5, 9, AX989, AY337, AZ5130; C.I. acid orange 5, 6, 7, 52; C.I. acid red 51, 73, 87, 92; C.I. acid violet 17, 19, AX990, AY338, C.I. acid yellow 36, 73, and the like), basic dyes (for example C.I. basic blue 8, 12, 15, 20, 26; C.I. basic green 1, 4; C.I. basic orange 2, AX998; C.I. basic red 1, 5, 9, 14, 15, AX992; C.I. basic violet 1, 2, 3, 4, 14; C.I. basic yellow 11, 13, and the like), direct dyes (for example C.I. direct red 2, 28; C.I. direct yellow 4, 9, 50, and the like), mordant dyes (for example C.I. mordant blue 3; C.I. mordant green 3; C.I. mordant orange 6; C.I. mordant red 3, 11; C.I. mordant violet 5, 25, 39; C.I. mordant yellow 1, 3, and the like); food dyes (such as C.I. food green 3, and the like), and mixtures thereof.

More specifically the first pH-sensitive dye (c) can be chosen in the group consisting of acid dyes (such as acid blue 93), more specifically in the group of acid dyes comprising sulfonate and/or sulfonic group(s) (SO₃H and/or SO₃M+ wherein M+ is the cationic counter ion such as alkali or alkaline earth metal).

In the present disclosure, the first pH-sensitive dye(s) (c) can either have one state which is colorless, or always be in a colored state. When the first pH-sensitive dye(s) (c) has one state which is colorless, then the color-changing ink composition of the disclosure comprises a non-pH sensitive dye(s) (d) and/or at least one second pH-sensitive dye (e) which is always colored.

According to a first embodiment of the present disclosure, the color-changing ink composition of the disclosure comprises at least one non-pH sensitive dye (d) and/or at least one second pH-sensitive dye (e) which is always colored, in addition to the first pH-sensitive dye(s) (c). More specifically, according to this embodiment, the first pH-sensitive dye(s) (c) can be colorless in one of its states, or alternatively can be always colored (i.e. always in a colored state).

According to a second embodiment of the present disclosure, the color-changing ink composition of the disclosure does not comprise any non-pH sensitive dye(s) (d). More specifically, according to this embodiment, the first pH sensitive dye(s) (c) is always colored (i.e. always in a colored state) According to this embodiment, the color-changing ink composition of the disclosure may also comprise at least an additional pH-sensitive dye(s) or not, and said additional pH-sensitive dye can be colorless in one of its states or alternatively can be always colored (i.e. always in a colored state).

According to the first embodiment described here-above, when the optional non-pH sensitive dye(s) (d) and/or optional second pH-sensitive dye(s) (e) which is always colored, is(are) present in the color-changing ink composition of the disclosure, the first pH-sensitive dye(s) (c) can be colorless in one of its states or alternatively can be always colored. More specifically, according to this first embodiment, the first pH-sensitive dye (c) can be chosen in the group consisting of acid dyes (for example C.I. acid black AX991, AY339; C.I. acid blue 1, 22, 74, 92, 93, 110, AX989, AX993, AX987; C.I. acid green 3, 5, 9, AX989, AY337, AZ5130; C.I. acid orange 5, 6, 7, 52; C.I. acid red 51, 73, 87, 92; C.I. acid violet 17, 19, AX990, AY338, C.I. acid yellow 36, 73, and the like), basic dyes (for example C.I. basic blue 8, 12, 15, 20, 26; C.I. basic green 1, 4; C.I. basic orange 2, AX998; C.I. basic red 1, 5, 9, 14, 15, AX992; C.I. basic violet 1, 2, 3, 4, 14; C.I. basic yellow 11, 13, and the like), direct dyes (for example C.I. direct red 2, 28; C.I. direct yellow 4, 9, 50, and the like), mordant dyes (for example C.I. mordant blue 3; C.I. mordant green 3; C.I. mordant orange 6; C.I. mordant red 3, 11; C.I. mordant violet 5, 25, 39; C.I. mordant yellow 1, 3, and the like); food dyes (such as C.I. food green 3, and the like), and mixtures thereof.

The second pH-sensitive dye(s) (e) which is always in a colored state can be chosen in the group consisting of acid dyes (for example C.I. acid black AX991, AY339; C.I. acid blue 1, 22, 74, 110, AX989, AX993, AX987; C.I. acid green 5, 9, AX989, AY337, AZ5130; C.I. acid orange 5, 6, 7, 52; C.I. acid red 73, 87; C.I. acid violet 17, AX990, AY338, C.I. acid yellow 36, 73, and the like), basic dyes (for example C.I. basic blue 8, 12, 15, 20, 26; C.I. basic green 1; C.I. basic orange 2, AX998; C.I. basic red 1, 5, 9, AX992; C.I. basic violet 1, 2, 3, 4, 14; C.I. basic yellow 11, 13, and the like), direct dyes (for example C.I. direct red 2, 28; C.I. direct yellow 4, 9, 50, and the like), mordant dyes (for example C.I. mordant blue 3; C.I. mordant green 3; C.I. mordant orange 6; C.I. mordant red 3, 11; C.I. mordant violet 5, 25, 39; C.I. mordant yellow 1, 3, and the like); food dyes (such as C.I. food green 3, and the like), and mixtures thereof.

According to the second embodiment described here-above, when the optional non-pH sensitive dye(s) (d) is absent from the color-changing ink composition of the disclosure (and when the color-changing ink composition of the disclosure does not either comprise an additional second pH-sensitive dye (e) which is always colored), the first pH-sensitive dye(s) (c) is always in a colored state. More specifically, according to this second embodiment, the first pH-sensitive dye(s) (c) can be chosen in the group consisting of acid dyes (for example C.I. acid black AX991, AY339; C.I. acid blue 1, 22, 74, 110, AX989, AX993, AX987; C.I. acid green 5, 9, AX989, AY337, AZ5130; C.I. acid orange 5, 6, 7, 52; C.I. acid red 73, 87; C.I. acid violet 17, AX990, AY338, C.I. acid yellow 36, 73, and the like), basic dyes (for example C.I. basic blue 8, 12, 15, 20, 26; C.I. basic green 1; C.I. basic orange 2, AX998; C.I. basic red 1, 5, 9, AX992; C.I. basic violet 1, 2, 3, 4, 14; C.I. basic yellow 11, 13, and the like), direct dyes (for example C.I. direct red 2, 28; C.I. direct yellow 4, 9, 50, and the like), mordant dyes (for example C.I. mordant blue 3; C.I. mordant green 3; C.I. mordant orange 6; C.I. mordant red 3, 11; C.I. mordant violet 5, 25, 39; C.I. mordant yellow 1, 3, and the like); food dyes (such as C.I. food green 3, and the like), and mixtures thereof. According to this second embodiment, the color-changing ink composition of the disclosure may also comprise at least one additional pH-sensitive dye(s) which can be colorless in one of its states or alternatively which can be always colored (i.e. always in a colored state), and which is as defined above for the first pH-sensitive dye.

In some embodiments, the total content of pH-sensitive dye(s) (first pH-sensitive dye (c) and optional second pH-sensitive dye(s) (e), which is always colored) ranges from 0.1 to 15% by weight, and more specifically from 0.5 to 10% by weight, relative to the total weight of the ink composition.

In some embodiments, the weight ratio of total content of pH-sensitive dye(s) (first pH-sensitive dye (c) and optional second pH-sensitive dye(s) (e)) to the content of volatile pH-modifier base (b) is about 1:100 to about 20:10, more specifically between about 1:10 to about 20:11.

The non-pH sensitive dye (d) of the disclosure may be chosen in the group consisting of direct dyes (for example C.I direct black 17, 19, 22, 32, 38, 51, 71; C.I direct yellow 26, 44; C.I direct red 1, 4, 23, 31, 37, 39, 75, 80, 81, 83, 225, 226, 227; C.I direct blue 1, 15, 41, 71, 86, 87, 106, 108, 199, and the like), acid dyes (for example C.I acid black 1, 2, 24, 26, 31, 52, 107, 109, 110, 119, 154; C.I acid yellow 1, 7, 17, 19, 23, 25, 29, 38, 42, 49, 61, 72, 78, 110, 127, 135, 141, 142; C.I acid red 8, 9, 14, 18, 26, 27, 33, 35, 37, 52, 57, 82, 83, 94, 111, 129, 131, 138, 186, 249, 254, 265, 276; C.I acid violet 15, 49; C.I acid blue 3, 7, 9, 15, 23, 25, 40, 41, 43, 62, 78, 83, 90, 100, 103, 104, 112, 113, 158; C.I acid green 16, 25, 27; C.I acid orange 56, and the like), and mixtures thereof.

In some embodiments, the content of non-pH sensitive dye(s) (d) ranges from 0 to 10% by weight, more specifically from 0.1 to 8% by weight, and even more specifically from 0.2 to 5% by weight, relative to the total weight of the ink composition.

The color-changing ink composition of the disclosure may further comprise at least one plasticizer. The plasticizer of the disclosure is chosen in the group consisting of alcohols, more specifically benzoate esters, diisobutyrate esters such as trimethyl pentanyl diisobutyrate, and mixtures thereof, and even more specifically benzoate esters, and mixtures thereof. According to some embodiment, the color-changing ink composition of the disclosure comprises as plasticizer at least one alcohol, more specifically wherein the at least one alcohol has a boiling point higher than 160° C.

In some embodiments, the content of plasticizer in the color-changing ink composition of the disclosure ranges from 0 to 40% by weight, more specifically 1 to 25% by weight, and even more specifically from 5 to 20% by weight, relative to the total weight of the ink composition.

The color-changing ink composition of the disclosure may further comprise additional additive(s) known by the skilled person to be usable in aqueous ink compositions, more specifically chosen in the group consisting of antimicrobial agent(s), co-solvent(s), antifungal agent(s), dispersing agent(s), antifoaming agent(s), corrosion inhibitor(s), gelling agent(s), thickening agent(s), surfactant(s), wetting agent(s), malodor counteractant(s), and mixtures thereof.

In some embodiments, the content of additional additive(s) in the ink composition of the disclosure ranges from 0.1 to 30% by weight, more specifically from 0.1 to 20% by weight, and even more specifically from 0.1 to 10% by weight, relative to the total weight of the ink composition.

The color-changing ink composition of the disclosure may more specifically contain at least one co-solvent such as:
glycols, such as ethylene glycol, diethylene glycol, triethylene glycol, polyethylene glycol (PEG), propylene glycol, and mixtures thereof,
glycol ethers such as ethylene glycol monomethyl ether, ethylene glycol monoethyl ether, diethylene glycol monomethyl ether, diethylene glycol monoethyl ether, diethylene glycol monobutyl ether, dipropylene glycol monomethyl ether, dipropylene glycol monobutyl ether, dipropylene glycol monopropyl ether, tripropylene glycol monomethyl ether, and mixtures thereof,
alcohols such as linear or branched alcohols in C₁-C₆, for example isopropanol, butanol, isobutanol, pentanol, benzyl alcohol, glycerin, diglycerin, polyglycerin, and mixtures thereof, and
their mixtures,
and other materials that are capable of increasing the viscosity of the ink composition of the disclosure. To achieve an ink composition with the appropriate viscosity to achieve gel-like shear-thinning properties, at least one co-solvent is added in a sufficient quantity to increase the viscosity of the ink composition of the disclosure from 3 to 15 mPas.s, more specifically ranging from 3 to 10 mPa.s, and even more specifically ranging from 3 to 7 mPa.s, which makes it more specifically suitable for use with a gel pen, a roller-pen, a free-ink pen, a felt-pen, a marker. The co-solvent may also act on the lubrication of the tip of the writing instrument, as well as on the final cap-off. When the co-solvent used is a polymer such as polyethylene glycol (PEG), the co-solvent can be selected with a wide range of viscosities and molecular weights, more specifically said polyethylene glycol (PEG) having a number average molecular weight Mn ranging from 200 to 1,000 g.mol⁻¹. When the co-solvent of the disclosure is polyethylene glycol (PEG), the latter may be commercially available under the name PLURIOL® E from BASF. More specifically, when the co-solvent is present in the color-changing ink composition of the disclosure, it is present in a content ranging from 5 to 25% by weight, and even more specifically from 10 to 25% by weight, relative to the total weight of the color-changing ink composition of the disclosure.

In some embodiments, the color-changing ink composition of the disclosure may contain at least one antimicrobial agent such as methyl paraben, phenoxyethanol, isothiazolinone, 1,2-benzoisothiazolin-3-one, 2-methyl-4-isothiazolin-3-one, and mixtures thereof.

In some embodiments, the antimicrobial agent(s) is present in the color-changing ink composition of the disclosure in a content ranging from 0.1 to 5% by weight, and even more specifically from 0.1 to 2% by weight, relative to the total weight of the ink composition.

In some embodiments, the color-changing ink composition of the disclosure may contain at least one thickening agent and/or at least one rheology-modifying agent such as polyvinylpyrrolidone (PVP), copolymers of PVP, polyvinylacetate, copolymers of PVA, and mixtures thereof. In some embodiments, the thickening agent(s) and/or the rheology-modifying agent(s) of the disclosure is present in a content ranging from 2 to 10% by weight, and even more specifically from 4 to 8% by weight, relative to the total weight of the color-changing ink composition of the disclosure.

The present disclosure also concerns a method for preparing a color-changing ink composition according to the disclosure, comprising the steps of adding under stirring:
(i) optional additive(s) to water (a), more specifically at a temperature ranging from 20 to 50° C.,
(ii) at least one first pH-sensitive dye (c), at least one optional non-pH sensitive dye (d), and at least one optional second pH-sensitive dye (e) which is always in a colored state, to the mixture obtained in step (i), more specifically at a temperature ranging from 20 to 50° C., and
(iii) at least one volatile pH-modifier base (b) to the mixture obtained in step (ii), more specifically at a temperature lower than 30° C., and even more specifically at a temperature lower than 25° C.

The water (a), the volatile pH-modifier base (b), the first pH-sensitive dye (c), the optional non-pH sensitive dye (d), and the optional second pH-sensitive dye (e) which is always in a colored state, as well as the optional additive(s), are as defined above for the color-changing ink composition of the disclosure.

During steps (i), (ii), and (iii), the ink ingredients are mixed under stirring at the temperatures indicated above, more specifically at a stirring speed ranging from 200 to 700 rpm, and even more specifically at a stirring speed of 300 rpm.

The ink composition obtained in steps (i), (ii), and (iii), can be homogenized during a certain period of time ranging from 3 to 20 minutes, and more specifically from 5 to 10 minutes.

The present disclosure also relates to the use of an ink composition according to the disclosure, as a color-changing ink composition showing, at room temperature (20° C.), an initial color A when applied to a substrate which changes to a second color B, which is different from initial (first) color A and which is not colorless, more specifically the color-change occurs within 30 minutes, more specifically within 15 minutes, after application to the substrate, and more specifically the color-change occurs within at least 10 seconds, and more specifically within at least 30 seconds, after application to the substrate.

In another aspect, the disclosure provides a method for writing on a substrate with a color-changing ink composition according to the disclosure, comprising the step of applying the ink composition to a substrate, the ink composition writing having a first (initial) color A when applied to the substrate which changes to a second color B, which is different from initial (first) color A and which is not colorless, at room temperature (20° C.), few minutes after application to the substrate. The change of color may occur within 30 minutes, more specifically within 15 minutes, after application to the substrate, and more specifically the color-change may occur within at least 10 seconds, and more specifically within at least 30 seconds, after application to the substrate.

The present disclosure also concerns a writing instrument comprising a color-changing ink composition according to the disclosure, wherein the writing instrument is a pen, more specifically chosen in the group consisting of a gel pen, a roller-pen, a free-ink pen, a felt-pen, a marker.

Another object of the present disclosure is a method for writing with a writing instrument according to the disclosure, comprising the step of writing on a substrate with a writing instrument as defined above, the ink composition writing having an initial color A when applied to the substrate which changes to a second color B, which is not colorless, few minutes after application to the substrate. The change of color may occur within 30 minutes, more specifically 15 minutes, after application to the substrate, and more specifically the color-change may occur within at least 10 seconds, and more specifically at least 30 seconds, after application to the substrate, at room temperature (20° C.).

The disclosure also relates to a kit comprising:
a writing instrument according to the present disclosure, and
an eradicator, more specifically chosen in the group consisting of sulfite, bisulfite, amine, and mixtures thereof, and even more specifically chosen in the group consisting of sodium sulfite, sodium glycinate, and mixtures thereof.

A method for writing on a substrate with a kit according to the present disclosure, comprising the steps of:
(i′) writing on a substrate with the writing instrument of the kit according to the disclosure,
(ii′) waiting for the ink composition writing to change color, more specifically at room temperature (20° C.), and more specifically within 30 minutes, and even more specifically within 15 minutes, after application to the substrate, and the color-change more specifically occurring within at least 10 seconds, and more specifically within at least 30 seconds, after writing on the substrate,
(iii′) applying the eradicator of the kit according to the disclosure, on a portion of the ink composition writing made with the writing instrument, and more specifically wherein the eradicator allows the ink composition writing to return to its initial (first) color.

Finally, another object of the present disclosure is a substrate coated with a color-changing ink composition according to the disclosure, wherein the substrate is more specifically a porous substrate, and even more specifically a porous substrate chosen in the group consisting of paper, printer paper or cardboard.

In addition to the foregoing, the disclosure also comprises other provisions which will emerge from the additional description which follows, which relates to the preparation of color-changing ink compositions according to the present disclosure.

### EXAMPLES

### Example 1: Preparation of a Color-Changing Ink Composition According to the Invention

A color-changing ink composition according to the present invention comprising the key ingredients of Table 1 was prepared:

TABLE 1

| Ingredients | Ink composition 1 according to the invention (% by weight) |
|---|---|
| Pluriol® E 200 (polyethylene glycol 200) (BASF) | 10.00 |
| Glycerin (1,2,3-propanetriol) | 8.00 |
| Acticide® MBS (mixture of 1,2-benzisothiazolin-3-one and 2-methyl-4-isothiazolin-3-one) | 0.19 |
| Additin® RC 8221 (methylbenzotriazole) | 0.20 |
| Xanthan gum | 0.40 |
| Demineralized water | 72.61 |
| TEGO® Foamex 810 (organo-modifed siloxane defoamer, polymer based defoamer) | 0.10 |
| Spectracid® AB93 (pH-sensitive dye, C.I. acid blue 93) | 3.00 |
| AR52 Dynasty (non-pH sensitive dye, C.I. acid red 52) | 0.50 |
| Dimethylamine at 40% in water (volatile pH-modifier base) | 5.00 |
| Total | 100% |

For a preparation of 100 g, 10 g of PEG 200 (Pluriol® E 200, BASF), 8 g of glycerin and 0.19 g of Acticide® MBS were put in a CLASSIC TANK at a temperature of 35° C., under slow stirring at 300 rpm. Then, 0.20 g of Additin® RC 8221 and 0.40 g of xanthan gum were slowly added, and left under slow stirring at 300 rpm during 15 minutes. Then, 72.61 g of water was slowly added to the mixture during 10 minutes, until a gel was formed. Agitation was increased for a vortex at 1,000 rpm, and left under stirring for 2.5 hours. Then, 0.10 g of TEGO® Foamex 810 was added and left under stirring at 1000 rpm during 30 minutes. Then, 3.00 g of Spectracid® AB93 and 0.50 g of AR52 Dynasty were also added and left under stirring at 1,000 rpm during 30 minutes. The heating was stopped and leave for 10 minutes in order to obtain a temperature of 20° C.

The ink composition was dispersed with a disperser IKA® with a module DR at 16,000 rpm. The dispersion process was stopped after 10 passes inside the disperser. Then, the ink composition was put under vigorous agitation with a pale type dispersion wheel at 1,000 rpm. Finally, 5.00 g of dimethylamine was added and left under stirring at 1,000 rpm during 30 minutes, under a temperature that does not exceed 30° C.

### Example 2: Preparation of a Color-Changing Ink Composition According to the Disclosure

A color-changing ink composition according to the present disclosure comprising the key ingredients of Table 2 was prepared.

TABLE 2

| Ingredients | Ink composition 2 according to the disclosure (% by weight) |
|---|---|
| Pluriol® E 200 (polyethylene glycol 200) (BASF) | 10.00 |
| Glycerin (1,2,3-propanetriol) | 8.00 |
| Acticide® MBS (mixture of 1,2-benzisothiazolin-3-one and 2-methyl-4-isothiazolin-3-one) | 0.19 |
| Additin® RC 8221 (methylbenzotriazole) | 0.20 |
| Xanthan gum | 0.40 |
| Demineralized water | 69.61 |
| TEGO® Foamex 810 (organo-modified siloxane defoamer, polymer based defoamer) | 0.10 |
| Spectracid® AB93 (pH sensitive dye, C.I. acid blue 93) | 3.00 |
| AR52 Dynasty (non-pH sensitive dye, C.I. acid red 52) | 0.50 |
| Dimethylamine at 40% in water (volatile pH-modifier base) | 8.00 |
| Total | 100% |

For a preparation of 100 g, 10 g of PEG 200 (Pluriol® E 200, BASF), 8 g of glycerin and 0.19 g of Acticide® MBS were put in a CLASSIC TANK at a temperature of 35° C., under slow stirring at 300 rpm. Then, 0.20 g of Additin® RC 8221 and 0.40 g of xanthan gum were slowly added, and left under slow stirring at 300 rpm during 15 minutes. Then, 69.61 g of water was slowly added to the mixture during 10 minutes, until a gel was formed. Agitation was increased for a vortex at 1,000 rpm, and left under stirring for 2.5 hours. Then, 0.10 g of TEGO® Foamex 810 was added and left under stirring at 1,000 rpm during 30 minutes. Then, 3.00 g of Spectracid® AB93 and 0.50 g of AR52 Dynasty were also added and left under stirring at 1000 rpm during 30 minutes. The heating was stopped and leave for 10 minutes in order to obtain a temperature of 20° C.

The ink composition was dispersed with a disperser IKA® with a module DR at 16,000 rpm. The dispersion process was stopped after 10 passes inside the disperser. Then, the ink composition was put under vigorous agitation with a pale type dispersion wheel at 1000 rpm. Finally, 8.00 g of dimethylamine was added and left under stirring at 1,000 rpm during 30 minutes, under a temperature that does not exceed 30° C.

### Example 3: Color-Changing Performances of the Prepared Color-Changing Ink Compositions 1 and 2

The color-changing performance, i.e. the capacity of a written mark made with the ink composition 1 or 2 previously prepared by applying it on a porous substrate in calligraph notebook (90 g/m², 210 × 297 mm, 80 pages, by Clairefontaine), was evaluated by visual assessment.

The color of the obtained written mark made on the porous substrate is called “color 1” and corresponds to the initial (first) color of the written mark (here color 1: pink), before evaporation at room temperature (20° C.) of dimethylamine. Then, after evaporation of the volatile pH-modifier base, the written mark made with the ink composition 1 or 2 changed color from its initial (first) color into a second color (here color 2: blue).

Color 2 was revealed in approximately 3 to 5 minutes after writing on the porous substrate for the ink composition 1 and around 10 minutes after writing on the porous substrate for the ink composition 2.

We claim:

1-15. (canceled)

16. A color-changing ink composition with two different states of color over time, an initial color A and then a second color B which is not colorless, comprising:
(a) water,
(b) at least one volatile pH-modifier base capable of evaporating at room temperature (20° C.), and
(c) at least one first pH-sensitive dye.

17. The color-changing ink composition according to claim 16, wherein the ink composition is exempt of eradicator agent.

18. The color-changing ink composition according to claim 16, wherein the at least one volatile pH-modifier base (b) has a vapor pressure ranging from 1 kPa to 1,000 kPa at room temperature (20° C.) and at constant air pressure.

19. The color-changing ink composition according to claim 16, wherein the at least one volatile pH-modifier base (b) has a boiling point of higher than -10° C. and of below 10° C.

20. The color-changing ink composition according to claim 16, wherein the at least one volatile pH-modifier base (b) is an aliphatic amine.

21. The color-changing ink composition according to claim 16, wherein the at least one volatile pH-modifier base (b) is a secondary aliphatic amine in C₁-C₆.

22. The color-changing ink composition according to claim 16, wherein the at least one volatile pH-modifier base (b) is chosen in the group consisting of methylamine, dimethylamine, diethylamine, triethylamine, or mixtures thereof.

23. The color-changing ink composition according to claim 16, wherein the at least one volatile pH-modifier base (b) is chosen in the group consisting of dimethylamine and/or diethylamine.

24. The color-changing ink composition according to claim 16, wherein the ink composition further comprises at least one non-pH sensitive dye (d) and/or at least one second pH-sensitive dye (e) which is always in a colored state.

25. The color-changing ink composition according to claim 24, wherein the least one first pH-sensitive dye (c) is chosen in the group consisting of acid dyes, basic dyes, direct dyes, mordant dyes; food dyes, and mixtures thereof.

26. The color-changing ink composition according to claim 16, wherein the least one first pH-sensitive dye (c) is always in a colored state.

27. The color-changing ink composition according to claim 26, wherein the least one first pH-sensitive dye (c) is chosen in the group consisting of acid dyes, basic dyes, direct dyes, mordant dyes; food dyes, and mixtures thereof.

28. The color-changing ink composition according to claim 26, wherein the composition is exempt of non-pH sensitive dye (d).

29. The color-changing ink composition according to claim 16, wherein the content of volatile pH-modifier base(s) (b) ranges from 0.8 to 6% by weight, relative to the total weight of the ink composition.

30. The color-changing ink composition according to claim 16, wherein the content of volatile pH-modifier base(s) (b) ranges from 1.6 to 4.8% by weight, relative to the total weight of the ink composition.

31. The color-changing ink composition according to claim 16, wherein the total content of pH-sensitive dye(s) (first pH-sensitive dye (c) and optional second pH-sensitive dye(s) (e) which is always in a colored state) ranges from 0.1 to 15% by weight, relative to the total weight of the ink composition.

32. The writing instrument comprising a color-changing ink composition according to claim 16, wherein the writing instrument is a pen.

33. A method for writing with a writing instrument according to claim 32, comprising the step of writing on a substrate with a writing instrument according to claim 32, the ink composition writing having an initial color A when applied to the substrate which changes, at room temperature (20° C.), to a second color B, which is different from initial (first) color A and which is not colorless.

34. The method for writing with a writing instrument according to claim 33, the ink composition writing having an initial color A when applied to the substrate which changes, at room temperature (20° C.), to a second color B, which is different from initial (first) color A and which is not colorless, the color-change occurring within at least 10 seconds, after application to the substrate and/or within 30 minutes, after application to the substrate.

35. A kit comprising:
a writing instrument according to claim 32, and
an eradicator.
